(19) United States
(12) Patent Application Publication
(10) Pub. No.: US 2013/0002205 A1
(43) Pub. Date: Jan. 3, 2013

(54) ELECTRONIC DEVICE PROVIDING CHARGED STATUS

(75) Inventor: XING-HUA TANG, Shenzhen City (CN)

(73) Assignees: HON HAI PRECISION INDUSTRY CO., LTD., New Taipei (TW); HONG FU JIN PRECISION INDUSTRY (ShenZhen) CO., LTD., Shenzhen City (CN)

(21) Appl. No.: 13/241,274

(22) Filed: Sep. 23, 2011

(30) Foreign Application Priority Data
Jun. 30, 2011 (CN) 201110181608.5

(51) Int. Cl. H02J 7/00

(52) U.S. Cl. 320/137

(57) ABSTRACT

An electronic device includes a power port connected to an external power source and configured for recharging a rechargeable battery of the electronic device. The electronic device further includes an LED module, an LED control switch, a battery management unit and a pulse signal generator. The battery management unit detects the status of the rechargeable battery and sends a signal to the LED control switch. The pulse signal generator generates pulsed signals at a predetermined frequency and sends the pulsed signals to the LED control switch. The LED control switch converts the pulse signal to a control signal according the status of the rechargeable battery, and sends the control signal to the LED module, the LED module is turned on and turned off by the LED control switch corresponding to the control signal, thus providing different indications of the status of the rechargeable battery.

### BACKGROUND

1. Technical Field

The present disclosure relates to electronic devices and, particularly, to an electronic device providing information as to the charged status thereof.

2. Description of Related Art

Some electronic devices use built-in rechargeable batteries as a power source, with an attendant requirement for frequent recharging thereof. During recharging, there is a need to indicate the charged status.

Very often, an electronic device indicates the charged status with characters or patterns displayed on the screen. However, the electronic device needs to be able to display or otherwise indicate the charged or discharged status of the battery, even when the electronic device is powered off.

Therefore, it is necessary to provide an electronic device providing the status of the battery so as to overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device which is able to provide information as to the charged status of a battery in accordance with a first embodiment.

FIG. 2 is a schematic diagram of the electronic device of FIG. 1.

FIG. 3 is a table showing the output status of a battery management unit of the electronic device of FIG. 1.

FIG. 4 is a block diagram of an electronic device providing charged status information in accordance with a second embodiment.

FIG. 5 is a schematic diagram of the electronic device of FIG. 4.

### DETAILED DESCRIPTION

The disclosure is illustrated by way of example and not by way of limitation. It should be noted that references to “an” or “one” embodiment in this disclosure are not necessarily to the same embodiment, and such references mean at least one.

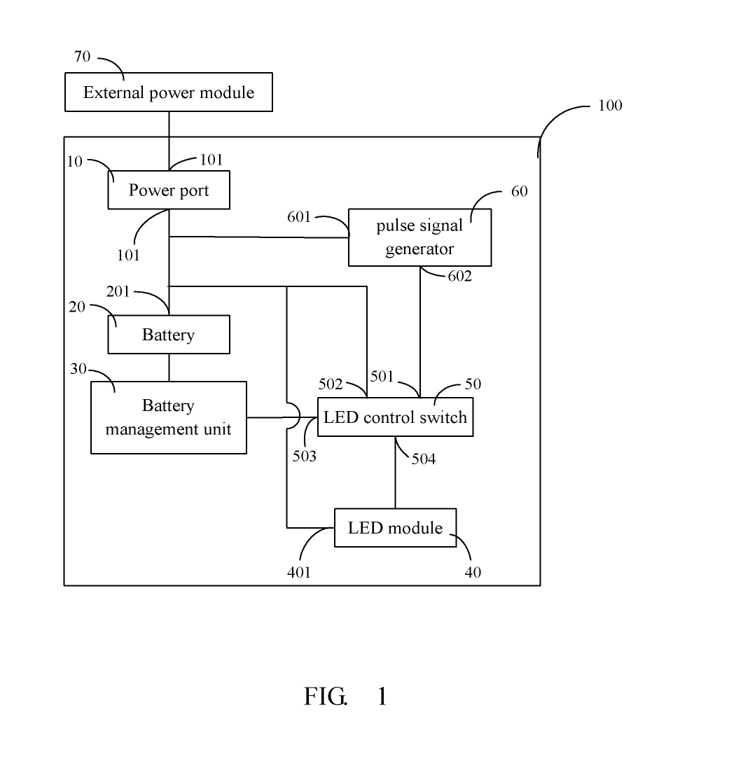

Referring to FIG. 1, an electronic device 100 which is able to provide information as to the status of a rechargeable battery 20 is illustrated. The electronic device 100 includes a power port 10, a rechargeable battery 20, a battery management unit 30, an LED (light emitting diode) module 40, an LED control switch 50 and a pulse signal generator 60. The electronic device 100 can be a portable DVD, a cell phone or other portable device using a rechargeable battery.

The power port 10 is configured to be connected to an external power module 70, the power port 10 includes an anode input terminal 101. The anode input terminal 101 is connected to the external power module 70. In this embodiment, the external power module 70 is an adapter. The external power module 70 is connected to the anode terminal 201 of the battery 20 via the power port 10, and is configured for recharging the battery 20. In another embodiment, the external power module 70 is a USB interface of a computer.

The battery management unit 30 is connected between the battery 20 and the LED control switch 50. The battery management unit 30 gets its power from the battery 20. The battery management unit 30 is configured to detect the status of the battery 20. The status of the battery 20 may be charged, discharged or abnormal. The discharged state means the battery 20 is full discharged and the connection between the battery 20 and the external power module 70 is switched off. The battery management unit 30 further sends a signal representing the status of the battery 20 to the LED control switch 50.

The pulse signal generator 60 includes an input terminal 601 connected to the anode input terminal 101 of the power port 10, and a pulse signal output terminal 602 connected to the LED control switch 50. The input terminal 601 receives power from the external power module 70, when the electronic device 100 is connected to the external power module 70. The pulse signal generator 60 generates and outputs pulse signals with a predetermined frequency to the LED control switch 50 via the pulse signal output terminal 602. In one embodiment, the pulse signal generator 60 generates positive and negative pulse signals alternately, distributed at a predetermined frequency. In alternative other embodiment, the pulse signal generator 60 generates pulse signals with positive pulse signals only, distributed in a predetermined frequency. The LED control switch 50 converts the pulse signals to a control signal, then the LED control switch 50 sends the control signal to the LED module 40, in accordance with the signal representing the status of the battery 20 received from the battery management unit 30. The current to the LED module 40 can be interrupted or resupplied, or interrupted and resupplied alternately by the LED control switch 50 corresponding to the control signal.

The LED control switch 50 includes a first input terminal 501, a second output terminal 502, a control terminal 503 and an output terminal 504. The first input terminal 501 is electronically connected to the pulse signal output terminal 602 of the pulse signal generator 60, and configured to receive the pulse signals from the pulse signal generator 60. The second input terminal 502 is connected to the anode input terminal 101 of the power port 10, and get power from the anode input terminal 101 when the electronic device 100 is connected to the external power module 70. The control terminal 503 is connected to the battery management unit 30, and the output terminal 504 is connected to the LED module 40. The battery management unit 30 detects the status of the battery 20 and sends a signal representing the status of the battery 20 to the control terminal 503 of the LED control switch 50.

In this embodiment, the LED module 40 includes at least one LED connected between the anode input terminal 101 of the power port 10 and the ground. The LED module 40 further includes an input terminal 401 connected to the output terminal 504 of the LED control switch 50, for receiving the control signal from the LED control switch 50.

When the battery 20 is in charged status, the LED control switch 50 allows the current to flow through the LED module 40, thus turning on and lighting the LED module 40. When the battery 20 is in discharged status, the LED control switch 50 interrupts the current flowing in the LED module 40, thus turning off the LED module 40. When the battery 20 is in an abnormal state, the LED control switch 50 interrupts and resupplies the current of the LED module 40 alternately, at a certain frequency, and accordingly the LED module 40 flashes.

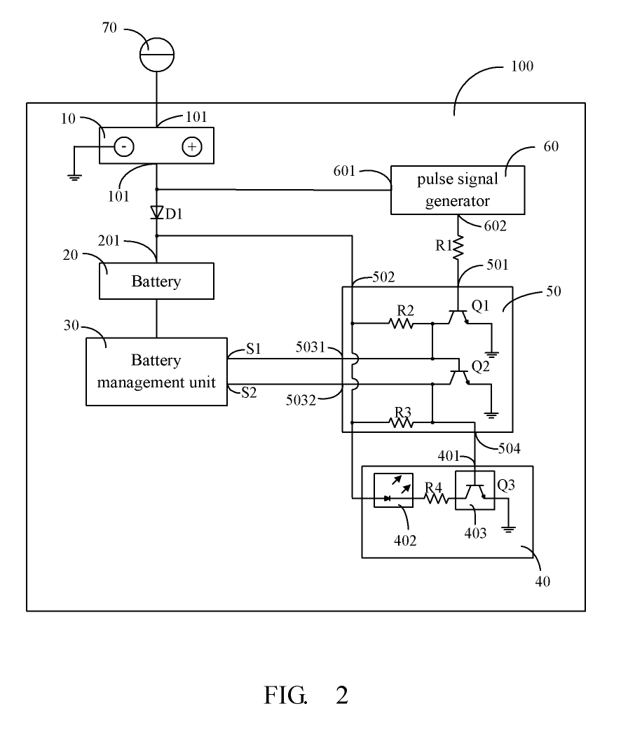

Referring to FIG. 2, the external power module 70 converts alternating current to direct current with a particular voltage value, and powers the electronic device 100. In one embodiment, the electronic device 100 further includes a diode D1 arranged between the anode terminal 201 of the battery 20 and the input terminal 601 of the pulse signal generator 60. The diode D1 conducts the power from the anode input terminal 101 to the anode terminal 201 when it is forward biased between the anode input terminal 101 and the anode terminal 201, thus preventing the battery 20 from providing power to the pulse signal generator 60 when no external power module 70 is connected to the battery 20.

In this embodiment, the battery management unit 30 can be a TPS54226 Texas Instrument (TI) chip, and the battery management unit 30 includes two signal output terminals S1 and S2. The control terminal 503 of the LED control switch 50 includes a first control terminal 5031 and a second control terminal 5032, the first control terminal 5031 is connected to the signal output terminal S1 and the second control terminal 5032 is connected to the signal output terminal S2. The battery management unit 30 detects the status of the battery 20 and sends a signal corresponding to the status via the signal output terminals S1 and S2. The LED control switch 50 receives the signal sent by the signal output terminals S1 and S2 via the first control terminal 5031 and the second control terminal 5032.

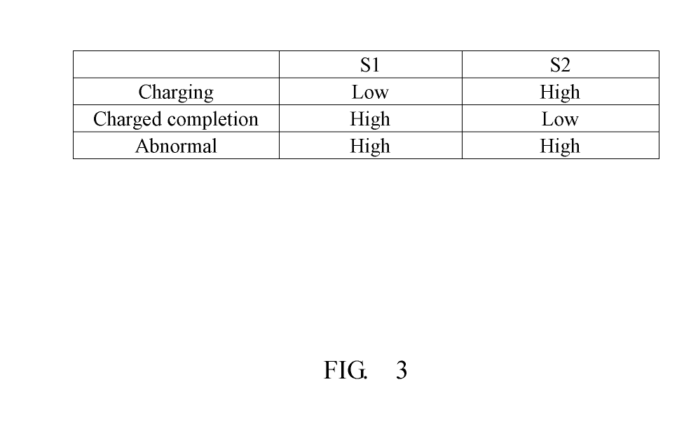

Referring to FIG. 3, the table shows the relationship between the output voltage status of the signal output terminal S1 and terminal S2, which is associated with the status of the battery 20. When the battery 20 is in a charged status, the signal output terminal S1 outputs a low voltage corresponding to logic “0” and the signal output terminal S2 outputs a high voltage corresponding to logic “1”. When the battery 20 is discharged, the signal output terminal S1 outputs a high voltage corresponding to the logic “1” and the signal output terminal S2 outputs a low voltage corresponding to logic “0”. When the battery 20 is in an abnormal status, the signal output terminals S1 and S2 simultaneously output a high voltage corresponding to logic “1”. In another embodiment, the battery management unit 30 can be a circuit for detecting the status of a battery, such as a circuit detecting and performing calculations concerning the output voltage of the battery

In this embodiment, the pulse signal generator 60 is an astable multivibrator configured to generate pulse signals at a predetermined frequency. In other embodiments, the pulse single generator 60 can be another type(s) of pulse-pattern generator.

The LED control switch 50 includes two negative-positive-negative (NPN) bipolar junction transistors (BJT) Q1 and Q2. The base of the NPN BJT Q1 constitutes a first input terminal 501. The emitter of the NPN BJT Q1 is grounded and the collector of the NPN Q1 is connected to the anode input terminal 101 of the power port 10, the signal output terminal S1 of the power management unit 30, and the base of the NPN BJT Q2. The resistor R2 is connected between the collector of the NPN Q1 and the anode input terminal 101. The emitter of the NPN BJT Q2 is grounded and the collector of NPN BJT Q2 is connected to the anode input terminal 101 of the power port 10, the signal output terminal S2 of the battery management unit 30 and the input terminal 401 of the LED module 40. A resistor R3 is connected between the collector of the NPN Q2 and the anode input terminal 101. The collector of NPN BJT Q2 constitutes the output terminal 504 of the LED control switch 50.

The LED module 40 includes at least one LED 402, a resistor R4 and a switch 403. In a first embodiment, the switch 403 is an NPN BJT Q3, the base of the NPN BJT Q3 constitutes the input terminal 401. The base of NPN BJT Q3 is connected to the signal output terminal S2 and the anode input terminal 101. A resistor R3 is connected between the base of the NPN Q3 and the anode input terminal 101. The collector of NPN BJT Q3 is connected to the LED 402, a resistor R4 is connected between the collector of the NPN Q3 and the LED 402, and the emitter of the NPN BJT Q3 is grounded.

When the electronic device 100 is connected to the external power module 70. The pulse signal generator 60 outputs pulse signals according to a predetermined frequency, to the base of the NPN BJT Q1.

When the battery 20 is in a charged status, the battery management unit 30 detect the charged status, the signal output terminal S1 outputs a low voltage to the base of the NPN BJT Q2, and the signal output terminal S2 outputs a high voltage to the base of NPN BJT Q3. In such a situation, the base of the NPN BJT Q2 receives the low voltage and turns off, whether the NPN BJT Q1 is turned on or off. The base of NPN BJT Q3 receives the high voltage output by the signal output terminal S2, and the NPN BJT Q3 is turned on. Accordingly, current is allowed to flow into the LED module 40, turning it on, and the LED module 40 lights.

When the battery 20 is in a discharged status, the battery management unit 30 detects the discharged status, the signal output terminal S1 outputs a high voltage to the base of the NPN BJT Q2, and the signal output terminal S2 outputs a low voltage to the base of NPN BJT Q3. In such a situation, the base of the NPN BJT Q3 receives a low voltage and turns off, whether the NPN BJT Q2 is turned on or off. Accordingly, the current flowing to the LED module 40 is interrupted, and the LED module 40 stops emitting light.

When the battery 20 is in an abnormal status, the battery management unit 30 detects the abnormal status, the signal output terminal S1 outputs a high voltage to the base of the NPN BJT Q2, and the signal output terminal S2 outputs a high voltage to the base of NPN BJT Q3. In the first embodiment, the pulse signal generator 60 generates positive and negative pulse signals alternately, distributed at a predetermined frequency. At this point, the pulse signals are positive pulse signals, the base of NPN BJT Q1 receives the positive pulse signals and the NPN BJT Q1 turns on. The base of the NPN BJT Q2 receives a low voltage because of the connection to the collector of the NPN BJT Q1 which is grounded, and the NPN BJT Q1 is turned on. Thus, the NPN BJT Q2 is turned off and the base of the NPN BJT Q3 receives the high voltage sent by the signal output terminal S2. Accordingly, the NPN BJT Q3 is turned on and the LED module 40 is illuminated. On the other hand, when the base of the NPN BJT Q1 receives the negative pulse signals, the NPN BJT Q1 turns off. The base of the NPN BJT Q2 receives the high voltage sent by the signal output terminal S1, and thus the NPN BJT Q2 turns on. The base of the NPN BJT Q3 receives a low voltage because of the connection to the collector of the NPN BJT Q2 which is grounded, and the NPN BJT Q2 is turned on. Accordingly, the NPN BJT Q3 is turned off and the LED module 40 stops emitting light. Therefore, the NPN transistor Q3 is successively turned on and off, according to the predetermined frequency of the pulse signals output by the pulse signal generator 60, and thus the LED module 40 flashes at the same frequency.

In another embodiment, the pulse signal generator 60 may generates pulse signals with positive pulse signals only, distributed at a predetermined frequency. At this point, the pulse signals are positive pulse signals, the base of NPN BJT Q1 receives the positive pulse signals, as described above, the NPN BJT Q1 turns on and the LED module 40 lights. Similarly, when the base of the NPN BJT Q1 does not receive the positive pulse signals, the NPN BJT Q1 turns off and the LED module 40 stops emitting light.

As disclosed, whether the electronic device 100 is powered on or off, the LED module 40 is capable of providing different indications as to the status of the electronic device 100. In detail, the electronic device directs the LED module to remain on when the battery 20 is charged, not to be illuminated when the battery 20 is in discharged status, and to flash whenever the battery 20 is in an abnormal state.

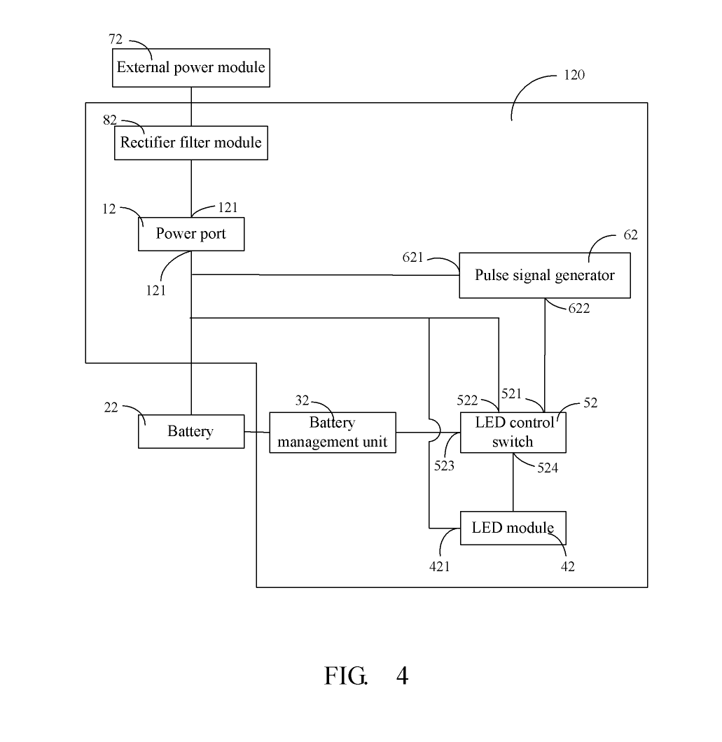

In another embodiment, the electronic device 100 can be a recharger or a power adapter for charging a rechargeable battery, with the particular function of indicating the status of the battery. Referring to FIG. 4, a recharger 120 with the function of providing information as to the status of a rechargeable battery 22 is illustrated in accordance with a second exemplary embodiment. The recharger 120 includes a rectifier filter module 82, a power port 12, a battery management unit 32, an LED module 42, a LED control switch 52 and a pulse signal generator 62.

The power port 12 includes an anode terminal 121, and the battery 22 is connected to the charger 120 via the power port 12. The rectifier filter module 82 is connected to an external power module 72. The rectifier filter module 82 converts alternating current to direct current with a particular voltage value, and can recharge the battery 22 via the anode terminal 121.

The battery management unit 32 is connected between the battery 22 and the LED control switch 52, the battery unit 32 get its power from the battery 22 and is used to detect the status of the battery 22 and send a signal representing the status of the battery 22 to the LED control switch 52. The status of the battery 22 may be charged, discharged or abnormal.

The pulse signal generator 62 includes an input terminal 621 connected to the anode terminal 101 of the power port 12, and a pulse signal output terminal 622 connected to the LED control switch control 52. The input terminal 621 receives the input power from the external power module 72. The pulse signal generator 62 generates and outputs pulse signals at a predetermined frequency to the LED control switch 52 through the pulse signal output terminal 622. In this embodiment, the pulse signal generator 62 generates pulse signals with alternating positive and negative pulse signals, at a predetermined frequency. The LED control switch 52 converts the pulse signals to a control signal, then the LED control switch 52 sends the control signal to the LED module 42, in accordance with the signal representing the status of the battery 22 received from the battery management unit 32. The current supplied to the LED module 42 can be switched off or switched on, or pulsed on and off by the LED control switch 52.

The LED control switch 52 includes a first input terminal 521, a second input terminal 522, a control terminal 523 and an output terminal 524. The first input terminal 521 is electrically connected to the pulse signal output terminal 622 of the pulse signal generator 62, and is configured to receive the pulse signals generated by the pulse signal generator 62. The second input terminal 522 is connected to the anode terminal 121 of the power port 12. The control terminal 523 is connected to the battery management unit 32, and the output terminal 524 is connected to the LED module 42. The battery management unit 32 detects the status of the battery 22 and sends a corresponding signal to the control terminal 523 of the LED control switch 52.

In this second embodiment, the LED module 42 includes at least one LED connected between the anode terminal 121 of the power port 12 and ground. The LED module 42 further includes an input terminal 421 connected to the output terminal 524 of the LED control switch 52, for receiving the signal sent from the LED control switch 52.

When the battery 22 is in charged status, the LED control switch 52 allows current to flow through the LED module 42, thus turning on and lighting the LED module 42. When the battery 22 is discharged, the LED control switch 52 does not supply current to the LED module 42, thus the LED module 42 is not lit. When the battery 22 is in an abnormal state, the LED control switch 52 pulses current to the LED module 42 in an alternating fashion and at a certain frequency, which causes the LED module 42 to flash.

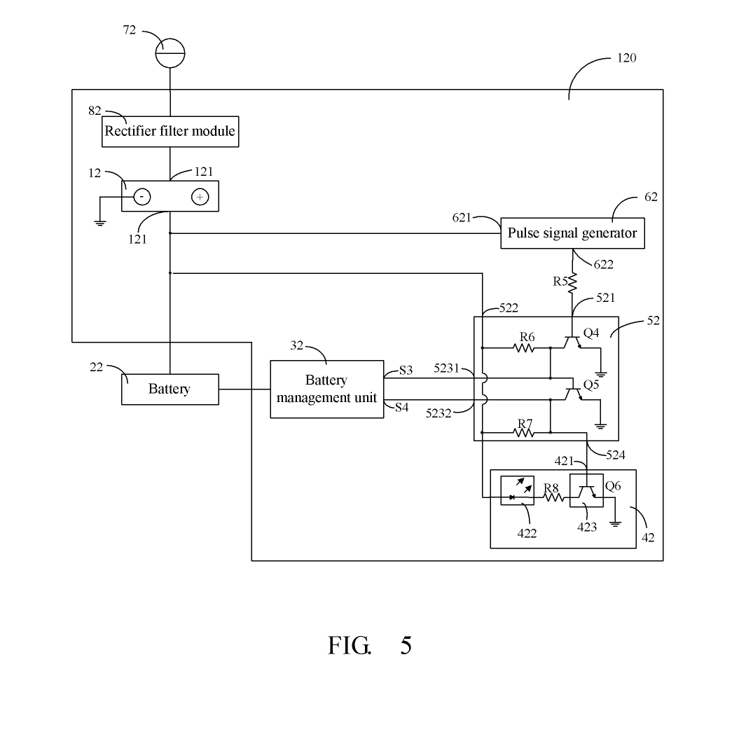

Referring to FIG. 5, in this second embodiment, the battery management unit 32 uses a TPS54226 Texas Instrument (TI) chip, and the battery management unit 32 includes two signal output terminals S3 and S4. The control terminal 523 of the LED control switch 52 includes a first control terminal 5231 and a second control terminal 5232, the first control terminal 5231 is connected to the signal output terminal S3 and the second control terminal 5232 is connected to the signal output terminal S4. The battery management unit 32 detects the status of the battery 22 and sends the signal corresponding the status via the signal output terminals S3 and S4. The LED control switch 52 receives the signal sent by the signal output terminals S3 and S4 via the first control terminal 5231 and the second control terminal 5232. When the battery 22 is in charged status, the signal output terminal S3 outputs a low voltage corresponding to logic “0” and the signal output terminal S4 outputs a high voltage corresponding to logic “1”. When the battery 22 is in discharged status, the signal output terminal S3 outputs a high voltage corresponding to the logic “1” and the signal output terminal S4 outputs a low voltage corresponding to logic “0”. When the battery 22 is in the abnormal status, the signal output terminal S3 and S4 simultaneously output a high voltage corresponding to logic “1”. In another embodiment, the battery management unit 32 can be a circuit for detecting the status of a battery, such as a circuit detecting the status via detecting and calculating the output voltage of the battery

In this embodiment, the pulse signal generator 62 is an astable multivibrator configured to generate pulse signals at a predetermined frequency. In other embodiments, the pulse single generator 62 can be another type of pulse-pattern generator.

The LED control switch 52 includes two negative-positive-negative (NPN) bipolar junction transistors (BJT) Q4 and Q5. The base of the NPN BJT Q4 constitutes a first input terminal 521. The emitter of the NPN BJT Q4 is grounded and the collector of the NPN Q4 is connected to the anode terminal 121 of the power port 12, the signal output terminal S3 of the power management unit 32 and the base of the NPN BJT Q5. A resistor R6 is connected between the collector of the NPN Q4 and the anode terminal 121. The emitter of the NPN BJT Q5 is grounded and a collector of NPN BJT Q5 is connected to the anode input terminal 121 of the power port 12, the signal output terminal S4 of the battery management unit 32 and the input terminal 421 of the LED module 42. A resistor R7 is connected between the collector of the NPN Q5 and the anode terminal 121. The collector of NPN BJT Q5 constitutes the output terminal 524 of the LED control switch 52.

The LED module 42 includes at least one LED 422, a resistor R8 and a switch 423. In the second embodiment, the switch 423 is a NPN BJT Q6, the base of the NPN BJT Q6 constitutes the input terminal 421. The base of NPN BJT Q6 is connected to the signal output terminal S4 and the anode terminal 121. A resistor R7 is connected between the base of the NPN Q6 and the anode terminal 121. The collector of NPN BJT Q6 is connected to the LED 422, a resistor R8 is connected between the collector of the NPN Q6 and the LED 422, and the emitter of NPN BJT Q6 is grounded.

When the recharger 120 is connected to the battery 22 and the external power module 72, the pulse signal generator 62 outputs the pulse signals according to a predetermined frequency to the base of the NPN BJT Q4.

When the battery 22 is in the charged status, the battery management unit 32 detect the charged status, the signal output terminal S3 outputs the low voltage to the base of the NPN BJT Q5, and the signal output terminal S4 outputs the high voltage to the base of NPN BJT Q6. In such a situation, the base of the NPN BJT Q5 receives the low voltage and turns off, whether the NPN BJT Q4 is turned on or turned off. The base of NPN BJT Q6 receives the high voltage output by the signal output terminal S4, the NPN BJT Q3 is turned on. Accordingly, the current is allowed to flow into the LED module 42 is turned on, and the LED module 42 lights.

When the battery 22 is in the discharged status, the battery management unit 32 detects the discharged status, the signal output terminal S3 outputs the high voltage to the base of the NPN BJT Q5, the signal output terminal S4 outputs the low voltage to the base of NPN BJT Q6. In such a situation, the base of the NPN BJT Q6 receives a low voltage and turns off, whether the NPN BJT Q5 is turned on or turned off. Accordingly, the current flowing in the LED module 42 is interrupted, and the LED module 42 stops emitting light.

When the battery 22 is in the abnormal status, the battery management unit 32 detects the abnormal status, the signal output terminal S3 outputs the high voltage to the base of the NPN BJT Q5, the signal output terminal S4 outputs the high voltage to the base of NPN BJT Q6. At this point, when the pulse signals are positive pulse signals, the base of NPN BJT Q4 receives the positive pulse signals and the NPN BJT Q4 turns on. The base of the NPN BJT Q5 receives a low voltage because of the connection to the collector of the NPN BJT Q4 which is grounded, and the NPN BJT Q1 is turned on. Thus, the NPN BJT Q5 is turned off and the base of the NPN BJT Q6 receives the high voltage sent by the signal output terminal S4. Accordingly, the NPN BJT Q6 is turned on and the LED module 42 is illuminated. On the other hand, when the base of the NPN BJT Q4 receives the negative pulse signals, the NPN BJT Q4 turns off. The base of the NPN BJT Q5 receives the high voltage send by the signal output terminal S3, and thus the NPN BJT Q5 turns on. The base of the NPN BJT Q6 receives a low voltage because of the connection to the collector of the NPN BJT Q5 which is grounded, and the NPN BJT Q5 is turned on. Accordingly, the NPN BJT Q6 is turned off and the LED module 42 stops emitting light. Therefore, the NPN transistor Q6 is turned on and off alternately according to the predetermined frequency of the pulse signals output by the pulse signal generator 62, accordingly, the LED module 42 flashes.

As disclosed, the recharger 120 as an electronic device is capable of providing different indications of the status of the battery 22.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a power port connected with an external power source and configured for recharging a rechargeable battery of the electronic device;
an LED (light emitting diode) module comprising at least one LED;
an LED control switch connected to the LED module;
a battery management unit connected between the rechargeable battery and the LED control switch, and configured for detecting status of the rechargeable battery and sending a signal representing the status of the rechargeable battery to the LED control switch; and
a pulse signal generator for generating and outputting pulse signals according to a predetermined frequency to the LED control switch;
wherein the LED control switch converts the pulse signals to a control signal, and sends the control signal to the LED module according to the signal representing the status of the battery received from the battery management unit, and the LED module is interrupted or resupplied, or interrupted and resupplied alternately by the LED control switch corresponding to the control signal.

2. The electronic device of claim 1, wherein the status of the rechargeable battery comprises charged status, discharged status and abnormal status.

3. The electronic device of claim 2, wherein
when the rechargeable battery is in the charged status, the LED control switch turns on the LED module and the at least one LED lights;
when the rechargeable battery is in the discharged status, the LED control switch turns off the LED module and the at least one LED stops emitting light; and
when the rechargeable battery is in the abnormal status, the LED control switch turns on and off the LED module alternately in a particular frequency, accordingly, the at least one LED flashes.

4. The electronic device of claim 2, wherein the battery management unit comprises a first signal output terminal and a second signal output terminal,
when the rechargeable battery is in the charged status, the first signal output terminal outputs a low voltage and the second signal output terminal outputs a high voltage;
when the rechargeable battery is in the discharged n status, the first signal output terminal outputs a high voltage and the second signal output terminal outputs a low voltage; and
when the rechargeable battery is in the abnormal status, the first signal output terminal and the second signal output terminal simultaneously output a high voltage.

5. The electronic device of claim 1, wherein the external power source is an adapter.

6. The electronic device of claim 1, wherein the pulse signal generator is an astable multi-vibrator.

7. The electronic device of claim 1, wherein the power port comprises an anode input terminal, the pulse signal generator comprises an input terminal, and the power port connects with the input terminal, the LED control switch and the LED module via the anode input terminal.

8. The electronic device of claim 7, wherein the electronic device further comprises a diode arranged between the rechargeable battery and the input terminal, and the diode conducts the power from the anode input terminal to the rechargeable battery when it is forwarded biased between the anode input terminal and the rechargeable battery.

9. The electronic device of claim 1, wherein the LED control switch comprises a first negative-positive-negative (NPN) bipolar junction transistor (BJT) and a second negative-positive-negative (NPN) bipolar junction transistor (BJT);
a base of the first NPN BJT connects to the pulse signal generator, an emitter of the first NPN BJT is grounded and a collector of the first NPN BJT is connected to the anode input terminal of the power port, the first single output terminal of the power management unit and a base of the second NPN BJT;
an emitter of the second NPN BJT is grounded and a collector of second NPN BJT is connected to the anode input terminal of the power port, the second signal output terminal of the battery management unit and the LED module.

10. The reflective display device of claim 9, wherein the LED module further includes a third NPN BJT, a base of the third NPN BJT is connected to the collector of second NPN BJT, the second signal output terminal and the anode input terminal, the emitter of the third NPN BJT is grounded, and the at least one LED is connected between the anode input terminal of the power port and an collector of the third NPN BJT.

11. A recharger comprising:
a rectifier filter module connected with an external power source, configured for converting alternating current provided by the external power source to direct current with a certain voltage value;
a power port connected with a rechargeable battery and configured for recharging the rechargeable battery;
an LED module comprising at least one LED;
an LED control switch connected to the LED module;
a battery management unit connected between the rechargeable battery and the LED control switch, and configured for detecting status of the rechargeable battery and sending a signal representing the status of the rechargeable battery to the LED control switch;
a pulse signal generator for generating and outputting pulse signals according to a predetermined frequency to the LED control switch;
wherein the LED control switch converts pulse signals to a control signal, and sends the control signal to the LED module according to the signal representing the status of the battery received from the battery management unit, and the LED module is interrupted or resupplied, or interrupted and resupplied alternately by the LED control switch corresponding to the control signal.

12. The electronic device of claim 11, wherein the status of the rechargeable battery comprises charged status, discharged status and abnormal status.

13. The electronic device of claim 12, wherein
when the rechargeable battery is in the charged status, the LED control switch turns on the current of the LED module and the at least one LED lights;
when the rechargeable battery is in the discharged status, the LED control switch turns off the current of the LED module and the at least one LED stops emitting light; and
when the rechargeable battery is the abnormal status, the LED control switch turns on and off the LED module alternately in a particular frequency, accordingly, the at least one LED flashes.

14. The electronic device of claim 12, wherein the battery management unit comprises a first signal output terminal and a second signal output terminal,
when the rechargeable battery is in the charged status, the first signal output terminal outputs a low voltage and the second signal output terminal outputs a high voltage;
when the rechargeable battery is in the discharged status, the first signal output terminal outputs a high voltage and the second signal output terminal outputs a low voltage; and
when the rechargeable battery is in the abnormal status, the first signal output terminal and the second signal output terminal simultaneously output a high voltage.

15. The electronic device of claim 11, wherein the pulse signal generator is an astable multi-vibrator.

16. The electronic device of claim 11, wherein the power port comprises an anode terminal, the pulse signal generator comprises an input terminal, and the power port connects with the input terminal, the LED control switch and the LED module via the anode terminal.

17. The electronic device of claim 11, wherein the LED control switch comprises a first negative-positive-negative (NPN) bipolar junction transistor (BJT) and a second negative-positive-negative (NPN) bipolar junction transistor (BJT);
a base of the first NPN BJT connects to the pulse signal generator, an emitter of the first NPN BJT is grounded and a collector of the first NPN BJT is connected to the anode terminal of the power port, the first single output terminal of the power management unit and a base of the second NPN BJT;
an emitter of the second NPN BJT is grounded and a collector of second NPN BJT is connected to the anode terminal of the power port, the second signal output terminal of the battery management unit and the LED module.

18. The reflective display device of claim 17, wherein the LED module further includes a third NPN BJT, a base of the third NPN BJT is connected to the collector of second NPN BJT, the second signal output terminal and the anode terminal, the emitter of the third NPN BJT is grounded, the at least one LED is connected between the anode terminal of the power port and an collector of the third NPN BJT.
